(19) United States
(12) Patent Application Publication
(10) Pub. No.: US 2009/0228315 A1
(43) Pub. Date: Sep. 10, 2009

(54) Project Assessment Using Project Yield Determination

(75) Inventors: William Joseph Athey, North Potomac, MD (US); Praduemn K. Goyal, Holmdel, NJ (US); David Patrick Ricci, Ocean Springs, MS (US)

Correspondence Address: DUKE W. YEE, YEE AND ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 12/043,750

(22) Filed: Mar. 6, 2008

(51) Int. Cl. G06Q 10/00

(52) U.S. Cl. 705/7

(57) ABSTRACT

Illustrative embodiments provide a computer implemented method, a data processing system and a computer program product for project assessment using project yield determination. In one embodiment, the computer implemented method comprises receiving project input to form received project data, and performing a first calculation on the received project data to create a project yield and performing a second calculation on the project yield to create a weighted project yield. The computer implemented method further performing a third calculation on the weighted project yield to create a sum of the weighted project yields, and determining whether the sum of the weighted project yields exceeds a predetermined value. Responsive to a determination that the sum of the weighted project yields exceeds the predetermined value, identifying a project associated with the sum of the weighted project yields to create an identified project, and selecting the identified project for delivery.

### BACKGROUND OF THE INVENTION

1. Field of the Invention

The present invention relates generally to an improved data processing system and more specifically to a computer implemented method, an apparatus and a computer program product for project assessment using project yield determination.

2. Description of the Related Art

Lack of good project portfolio planning by a business combined with a lack of control on the factory intake by the information technology facet typically results in a work program that often exceeds capacity. At the same time, the work program often entails higher than acceptable levels of risk, in attempting to deliver suboptimal business value.

In these situations, projects are typically reduced in size and scope, or even jettisoned late in design and development cycle. Suboptimal choices are often forced upon the project by schedule and capacity constraints. The end result becomes evident in the form of a loss of business value and wasted information technology investments.

Repeated occurrences produce a downward spiral of results. The accumulation of losses and wasted resources causes fewer projects to be accepted and planned for implementation. The whole process shifts to a mindset of being risk adverse and avoiding change. While change is required to grow the business there is greater reluctance to accept a change when the change cannot be quantified and/or justified.

### BRIEF SUMMARY OF THE INVENTION

According to one embodiment of the present invention, a computer implemented method for project assessment using project yield determination is provided. The computer implemented method comprises receiving project input to form received project data, and performing a first calculation on the received project data to create a project yield and performing a second calculation on the project yield to create a weighted project yield. The computer implemented method further performing a third calculation on the weighted project yield to create a sum of the weighted project yields, and determining whether the sum of the weighted project yields exceeds a predetermined value. Responsive to a determination that the sum of the weighted project yields exceeds the predetermined value, identifying a project associated with the sum of the weighted project yields to create an identified project, and selecting the identified project for delivery.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of high level components for project yield determination in accordance with illustrative embodiments;

FIG. 4 is a block diagram of project factors in accordance with illustrative embodiments; and

FIG. 5 is a flowchart of a project assessment using project yield determination process in accordance with illustrative embodiments.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

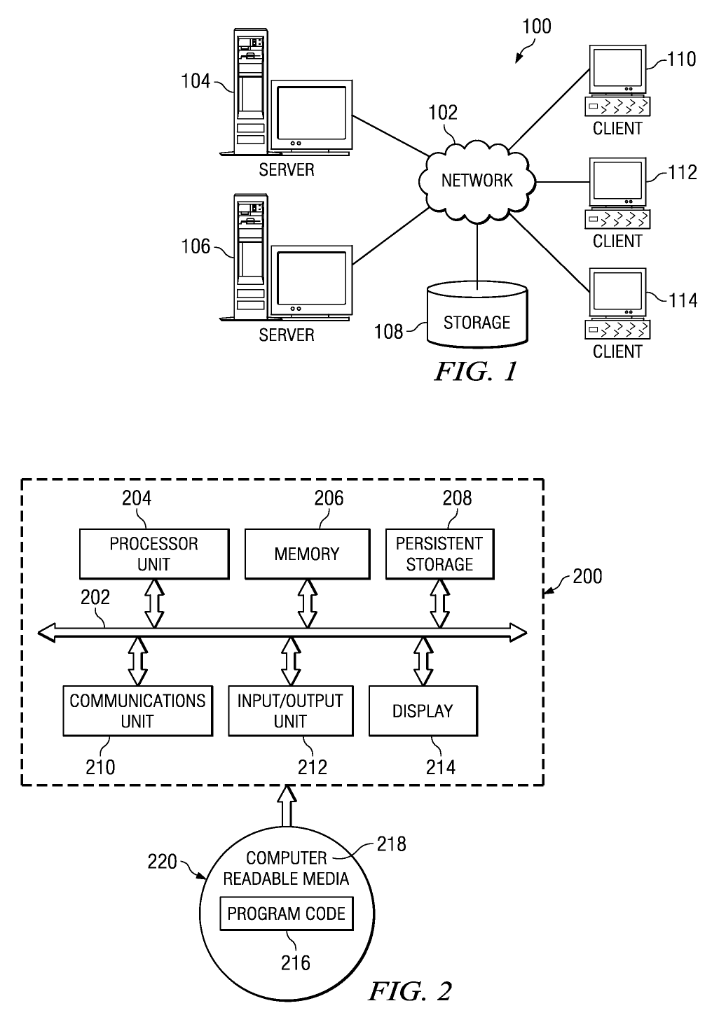

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

By way of example, a proposed quantitative analysis technique for early prediction of delivered business value and time-to-market, based on business, operational and information technology attributes that may be gathered from client 110 and client 112 on network 102 as project related information used in project yield determination and stored on server 104. A yield management model, in this example using data stored on server 104, assigns a yield score to a project based on actual delivery performance in prior releases, and can be used to assess and identify high risk low business value projects. Alternatively data captured on a client may also be calculated on client 110 and client 112. Further, identification may allow adoption of available risk mitigation strategies for high value high risk projects. Yield analysis performed, on server 104, can also be used for risk mitigation typically resulting in increased delivery confidence, enhanced business value and productivity, and reduced overall costs and time-to-market, communicated back to users on client 110 and client 112 through network 102.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

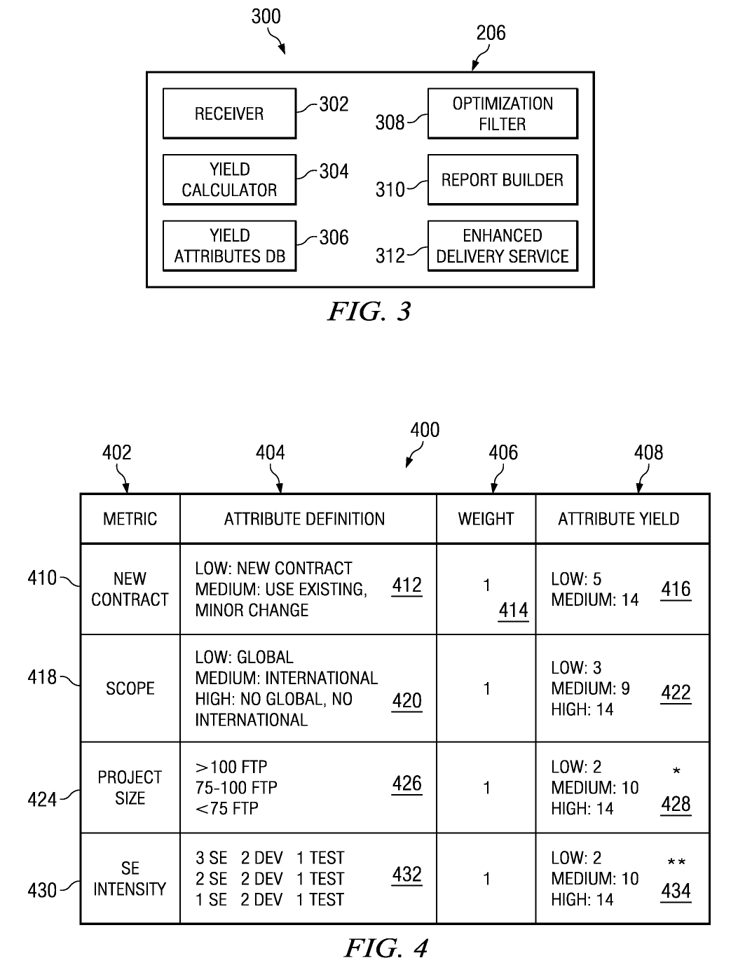

With reference to FIG. 3, a block diagram of high level components for project assessment using project yield determination 300 in accordance with illustrative embodiments is shown. Components used for project yield determination 300 include a number of special components comprising a receiver 302, a yield calculator 304, a yield attributes database 306, an optimization filter 308, a report builder 310 and enhanced delivery services 312. These components combine with typical underlying system components, to provide a capability to generate an estimated project yield. The project yield is a calculated score used in determining the feasibility of implementing a project.

The components of project yield determination 300 are shown placed within memory 206 of system 200 of FIG. 2. The components may exist on a storage medium until required for use, being combined as needed. Receiver 302 is used to accept input for project factors that are used in subsequent calculations. Receiver 302 may be implemented in the form of a graphical user interface that provides an easy to use input mechanism to receive project related information from users. Receiver 302 may also provide a programmatic mechanism to gather information from sources such as project code or documents.

Yield calculator 304 provides the capability of performing calculations using routines created for the yield determination. For example yield calculator 304 includes arithmetic operations to perform calculations on the project input values. Calculations involve standard arithmetic computations on the values found in yield attributes database 306. Yield attributes database 306 contains the various input values related to a project. In this example, a database is used, but other suitable storage formats may also be used such as files, or folders.

Optimization filter 308 performs an assessment, identification and selection of projects after the calculations have been performed. Filtering allows for projects to be identified relative to a threshold as defined by previous project implementation history of the project managers or other metric such as a industry project management metric. Optimization affords the opportunity to rework those projects that need to have additional processing before being ready to release or projects that need to be revisited before any further processing.

Report builder 310 provides a documented output of the results of project yield determination. In a typical example, the report may be a simple listing of a project's determined yield or score. A report typically is sent to a graphical user interface capable device.

Enhanced delivery services 312 are a set of services defined to provide a capability to rework projects determined to be less than ready for delivery. Identified projects, such as medium level projects, may need additional units of system engineering time or some other special processing or resource added to raise the project to the point of a ready to deliver project. Services may be related to the project metrics derived from project input values.

By way of example, the combination of components just described provide a proposed quantitative analysis technique for early prediction of delivered business value and time-to-market, based on business, operational and information technology attributes. A yield management model, in this example, assigns a yield score to a project based on actual delivery performance in prior releases, and can be used to identify high risk low business value projects. Further, identification may allow adoption of available risk mitigation strategies for high value high risk projects. Yield analysis can also be used for risk mitigation typically resulting in increased delivery confidence, enhanced business value and productivity, and reduced overall costs and time-to-market.

Projects, in the example, are defined to have categories of information technology (IT) attributes and related values, business and operational (B&O) attributes and related values. In addition weight factors are also defined for each category to further modify the attribute values. Additionally attribute value improvement methods are defined for each category, as found in enhanced delivery services 312.

Category scores for each of information technology and business and operational is calculated. In addition a weighted score for the combination of information technology and business and operational categories is calculated to produce a project yield. Further a weighted project yield is calculated from the multiplication of the project yield by the project size. The project size is determined by the number of function points. A function point is a typical method of sizing a project by deliverable units.

A release yield is then determined by a normalized sum of the various weighted project yields. A yield management optimization filter is then applied. The optimization filter is a technique of applying a threshold to assess and classify projects by yield. Application of enhanced delivery models selected projects to maximize yield may also be performed.

Continuous yield management may also be employed to further optimize the results obtained by using actual results from prior project releases to adjust current attribute values and weights.

With reference to FIG. 4, a block diagram of project factors in accordance with illustrative embodiments is shown in a tabular form. Project factors 400, in this example, is a matrix of values showing a relationship between metrics 402, attribute definitions 404, weight 406 and attribute yield 408.

Metric 402 defines an element being measured or quantified within the context of categories of a business and operational attribute or an information technology attribute. Other categories may be defined as used as needed.

Attribute definition 404 describes the characteristics of a specific metric in terms that relate to the specific metric. In some cases the attributes may be text descriptors while in other cases use of numeric values may be more appropriate.

Weight 406 is a factoring element that can be used to adjust the importance of a metric or an attribute definition within. Typically a weight is initialized to 1 and may be changed based on empirical data.

Attribute yield 408 is resultant value determined from previous project related outcome experiences. Typically the values would be from previous projects adjusted to reflect more recent experiences. In some cases the values may be adjusted up or down based on specific instances of the individual metric.

For example, metric 410 is a metric for a “new contract” in the business or operational category 436. Attribute definition 412 applied in this case are “low: new contract” describing an attribute of using a new contract and “medium: use existing with minor change.” The low indicates a less desirable situation, associated with the use of a new contract as compared with a previous used or familiar contract. In this example the weight 414 is “1” indicating no change in values. Attribute yield 416 indicates the yield for this specific metric, in this case a “low: 5” and a “medium 14” value.

Metric 418 defines a scope of the project. Attribute definition 420 defines a low scope of global, a medium scope of international and a high scope of no global and no international, indicating a more local project. Attribute yield 422 provides a corresponding set of attribute yields of 3, 9 and 14 indicating a preference for local projects.

Project size 424 is a first entry from the information technology category 438, defining a relative size of the project. Attribute definition 426 provides values in ranges of greater than 100 function points, between 75 and 100 function points and less than 75 function points. Function points define deliverable units of function in the project. Attribute yield 428 provides the yields corresponding to the function point ranges as values of 2, 10 and 14.

SE intensity 430 defines the relative complexity of the project in terms of skilled resources related to information technology. Attribute definition 432 provides three sets of values using system engineering, developer and tester resource skills. The resource quantification specifies the amount and type of resource from information technology personnel that is required for the project. Attribute yield 434 provides the corresponding values for the respective resource set of attribute definition 432 in values of 2, 10 and 14.

In this example a simple table is used to illustrate the type of information needed and collected. The table provides a relatively simple manner to show relationships for elements in the project. The table may be many tables, wherein tables may be arranged by functional area providing the input. The table shown groups both business and operational elements with information technology elements but this need not be the case. Each category may have a table or set of tables as necessary or desired.

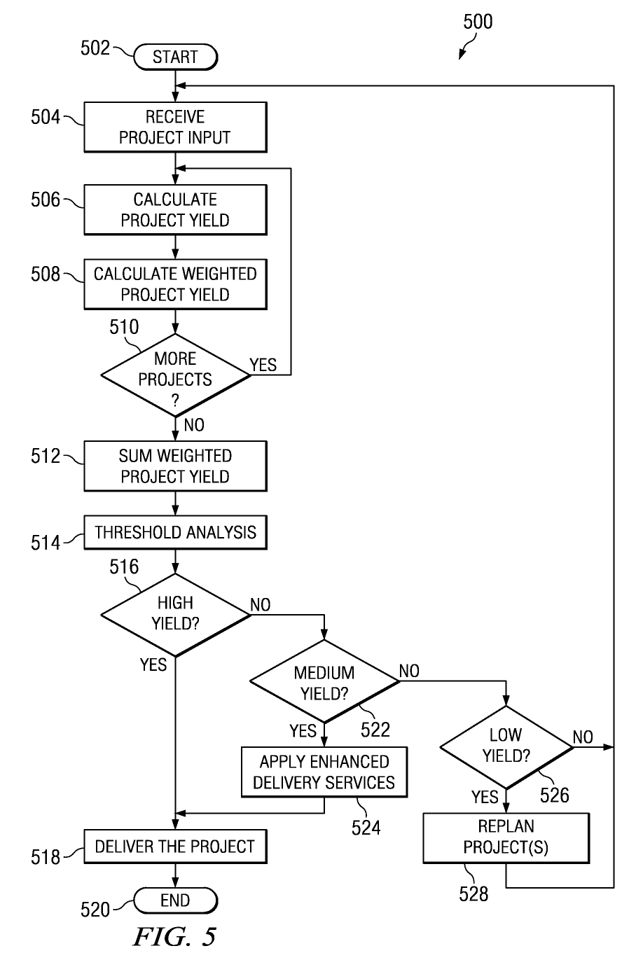

With reference to FIG. 5, a flowchart of a project assessment using project yield determination process in accordance with illustrative embodiments is shown. Process 500, is an example of an embodiment of project assessment using project yield determination 300 of FIG. 3.

Process 500 starts (step 502) and receives project input (step 504). Project input may be received from sources such as user provided data entry through a graphical user interface or programmatic means including, but not limited to using source code analysis or project document scanning and interpretation. The project input is received to form received project data.

A yield for the project is calculated (step 506). Yield calculation comprises determining the weighted sum of the business and operational and information technology yields. With reference to the example of project factors 400 of FIG. 4 a first calculation is as follows: Project Yield=(w1*(B&O Yield)+w2*(IT Yield))/(w1+w2). Variables w1 and w2 are the weighting assigned to business and operational and information technology scores. Variable B&O represents the business and operational category metric and variable IT represents the information technology category metric used.

A weighted project yield is then calculated (step 508). The weighted project yield is calculated as the product of the project yield and project size, in function points or other similar measure of function deliverable. A second calculation for the weighted project yield may be expressed as follows: weighted project yield=project yield*number of function points. As shown in metric 424 of FIG. 4, defining project size function points can be assigned in ranges dependent upon the size of the project. Larger projects typically deliver more function and hence function points.

A determination is made whether there are more projects to be processed (step 510). If there are more projects to be processed a “yes” is obtained in step 510. If there are no more projects to be processed a “no” results. If there is a “yes” in step 510, process 500 returns to step 506 to calculate project yields. If the result of step 510 was a “no”, a sum of the weighted project yields is calculated (step 512). The release yield is the weighted average of project yields of all projects that comprise the release. A third calculation of the release yield may be as follows: release yield=Σ(project yield*number of function points)/Σ(number of function points).

A threshold analysis is performed to determine optimization opportunities and a need for additional processing step 514). Additional processing on identified projects may provide an enhanced yield for the project. In this example a series of thresholds is used to classify project opportunities as high, medium and low in terms of yield. Further classes may be used to refine the identification of opportunities as needed. In the example there is a first threshold, a second threshold and a third threshold to determine a classification of a project yield. The project score cascades down the thresholds from project scores having a high yield to project scores having a low yield. Similarly, the thresholds may also be reversed in order to accomplish the same results. A determination is made whether the project “score” indicates a high yield (step 516). If the project score is greater than a predetermined threshold, the result is a “yes.” If the score is less than the threshold, then the result is a “no.” If a “yes” was obtained in step 516, a project is determined to be ready for delivery (step 518) with process 500 terminating thereafter (step 520).

If the result of step 516 was “no” a determination is made whether the project “score” indicates a medium yield (step 522). If the project score is greater than a predetermined threshold, the result is a “yes.” If the score is less than the threshold, then the result is a “no.” If a “yes” was obtained in step 522, a project is determined to be a candidate for enhanced delivery services (step 524). Enhanced delivery services may be applied to improve the yield of the identified project. These services may involve extra testing or minor changes and not significant rework.

If the result of step 522 was “no” a determination is made whether the project “score” indicates a low yield (step 526). If the project score is greater than a predetermined threshold, the result is a “yes.” If the score is less than the threshold, then the result is a “no.” If a “yes” was obtained in step 526, a project is determined to be a low yield and a candidate for more work. The work typically involves a re-plan exercise for the project (step 528). If the result of step 526 was “no” process 500 returns to step 504 to receive more project input.

Optionally, a form of continuous evaluation and optimization may be applied wherein data from each project processed may be added to the collection of information in the yield attributes database 306 of FIG. 3 and represented in project factors 400 of FIG. 4. In this example, the data collected could be used to further validate the project metrics of new projects through updated data.

By way of example, a proposed quantitative analysis technique for a prediction of a project yield has been shown. Project yield is defined as delivered business value and time-to-market, based on business, operational and information technology attributes that may be gathered from various input sources including users, source code and documentation comprising project related information. The information is then quantified and calculated to provide a project yield determination A yield management model, in this example using the project data can also assign a yield score to a project based on actual delivery performance in prior releases, and can be used to identify high risk low business value projects.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for project assessment using project yield determination, the computer implemented method comprising:
receiving project input to form received project data;
performing a first calculation on the received project data to create a project yield;
performing a second calculation on the project yield to create a weighted project yield;
performing a third calculation on the weighted project yield to create a sum of the weighted project yields;
determining whether the sum of the weighted project yields exceeds a predetermined value; and
responsive to a determination that the sum of the weighted project yields exceeds the predetermined value, identifying a project associated with the sum of the weighted project yields to create an identified project, and selecting the identified project for delivery.

2. The computer implemented method for project yield determination of claim 1, wherein the received project data is obtained from one or both of a user input and a programmatic method.

3. The computer implemented method for project yield determination of claim 1, wherein the step of determining whether the sum of the weighted project yields exceeds a predetermined value further comprises:
responsive to a determination that the sum of the weighted project yields fails to exceed the predetermined value, determining whether the sum of the weighted project yields exceeds a second threshold value;
responsive to a determination that the sum of the weighted project yields exceeds the second threshold value identifying a project associated with the sum of the weighted project yields to create an identified project, and applying a selected enhanced delivery service to the identified project.

4. The computer implemented method for project yield determination of claim 3, wherein the step of determining whether the sum of the weighted project yields exceeds the second threshold value further comprises:
responsive to a determination that the sum of the weighted project yields fails to exceed the second threshold value, determining whether the sum of the weighted project yields exceeds a third threshold;
responsive to a determination that the sum of the weighted project yields exceeds the third threshold identifying a project associated with the sum of the weighted project yields to create an identified project, and sending the identified project for re-planning.

5. The computer implemented method for project yield determination of claim 3, wherein the step of determining whether the sum of the weighted project yields exceeds the second threshold further comprises:
responsive to a determination that the sum of the weighted project yields fails to exceed the second threshold value, determining whether the sum of the weighted project yields exceeds a third threshold;
responsive to a determination that the sum of the weighted project yields fails to exceed the third threshold identifying a project associated with the sum of the weighted project yields to create an identified project, resubmitting the identified project as project input.

6. A data processing system for project assessment using project yield determination, the data processing system comprising:
a bus;
a memory connected to the bus, the memory comprising computer executable instructions;
a processor unit connected to the bus, wherein the processor unit executes the computer executable instructions to direct the data processing system to:
receive project input to form received project data;
perform a first calculation on the received project data to create a project yield;
perform a second calculation on the project yield to create a weighted project yield;
perform a third calculation on the weighted project yield to create a sum of the weighted project yields;
determine whether the sum of the weighted project yields exceeds a predetermined value; and
responsive to a determination that the sum of the weighted project yields exceeds the predetermined value, identify a project associated with the sum of the weighted project yields to create an identified project, and select the identified project for delivery.

7. The data processing system for project yield determination of claim 6, wherein the received project data is obtained from one or both of a user input and a programmatic method.

8. The data processing system for project yield determination of claim 6, wherein the processor unit executes the computer executable instructions to direct the data processing system to determine whether the sum of the weighted project yields exceeds a predetermined value further comprises:
responsive to a determination that the sum of the weighted project yields fails to exceed the predetermined value, determine whether the sum of the weighted project yields exceeds a second threshold value; and
responsive to a determination that the sum of the weighted project yields exceeds the second threshold value identify a project associated with the sum of the weighted project yields to create an identified project, and apply a selected enhanced delivery service to the identified project.

9. The data processing system for project yield determination of claim 8, wherein processor unit executes the computer executable instructions to direct the data processing system to determine whether the sum of the weighted project yields exceeds the second threshold value further comprises:
responsive to a determination that the sum of the weighted project yields fails to exceed the second threshold value, determine whether the sum of the weighted project yields exceeds a third threshold; and
responsive to a determination that the sum of the weighted project yields exceeds the third threshold identify a project associated with the sum of the weighted project yields to create an identified project, and send the identified project for re-planning.

10. The data processing system for project yield determination of claim 8, wherein processor unit executes the computer executable instructions to direct the data processing system to determine whether the sum of the weighted project yields exceeds the second threshold further comprises:
responsive to a determination that the sum of the weighted project yields fails to exceed the second threshold value, determine whether the sum of the weighted project yields exceeds a third threshold;
responsive to a determination that the sum of the weighted project yields fails to exceed the third threshold identify a project associated with the sum of the weighted project yields to create an identified project, and resubmit the identified project as project input.

11. A computer program product for project assessment using project yield determination, the computer program product comprising:
a computer-usable recordable medium embodying computer executable instructions thereon, the computer executable instructions comprising;
computer executable instructions for receiving project input to form received project data;
computer executable instructions for performing a first calculation on the received project data to create a project yield;
computer executable instructions for performing a second calculation on the project yield to create a weighted project yield;
computer executable instructions for performing a third calculation on the weighted project yield to create a sum of the weighted project yields;
computer executable instructions for determining whether the sum of the weighted project yields exceeds a predetermined value; and
computer executable instructions responsive to a determination that the sum of the weighted project yields exceeds the predetermined value, for identifying a project associated with the sum of the weighted project yields to create an identified project, and selecting the identified project for delivery.

12. The computer program product for project yield determination of claim 11, wherein the received project data is obtained from one or both of a user input and a programmatic method.

13. The computer program product for project yield determination of claim 11, wherein the computer executable instructions for determining whether the sum of the weighted project yields exceeds a predetermined value further comprises:
computer executable instructions responsive to a determination that the sum of the weighted project yields fails to exceed the predetermined value, for determining whether the sum of the weighted project yields exceeds a second threshold value;
computer executable instructions responsive to a determination that the sum of the weighted project yields exceeds the second threshold value for identifying a project associated with the sum of the weighted project yields to create an identified project, and applying a selected enhanced delivery service to the identified project.

14. The computer program product for project yield determination of claim 13, wherein the computer executable instructions for determining whether the sum of the weighted project yields exceeds the second threshold value further comprises:
computer executable instructions responsive to a determination that the sum of the weighted project yields fails to exceed the second threshold value, for determining whether the sum of the weighted project yields exceeds a third threshold;
computer executable instructions responsive to a determination that the sum of the weighted project yields exceeds the third threshold for identifying a project associated with the sum of the weighted project yields to create an identified project, and sending the identified project for re-planning.

15. The computer program product for project yield determination of claim 13, wherein the computer executable instructions for determining whether the sum of the weighted project yields exceeds the second threshold further comprises:
computer executable instructions responsive to a determination that the sum of the weighted project yields fails to exceed the second threshold value, for determining whether the sum of the weighted project yields exceeds a third threshold;
computer executable instructions responsive to a determination that the sum of the weighted project yields fails to exceed the third threshold for identifying a project associated with the sum of the weighted project yields to create an identified project, resubmitting the identified project as project input.
